(19) United States
(12) Patent Application Publication
(10) Pub. No.: US 2010/0076796 A1
(43) Pub. Date: Mar. 25, 2010

(54) System and Method for Baggage Issue

(75) Inventors: Cornel Klein, Oberhaching (DE); Thorsten Schöler, Kaufbeuren (DE); Thomas Wagner, Bubenreuth (DE); Roland Ziegler, Fürth (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/565,900

(22) Filed: Sep. 24, 2009

(30) Foreign Application Priority Data
Sep. 24, 2008 (DE) 10 2008 048 741.4

(51) Int. Cl. G06Q 50/00; G08B 13/14; H04M 1/00; G06Q 10/00; G09F 3/02; B65G 43/08; G05B 19/00

(52) U.S. Cl. 705/5; 340/572.1; 40/6; 198/340; 340/5.82; 340/5.83; 455/556.1

(57) ABSTRACT

A baggage issuing facility for issuing baggage items to passengers is provided in this case. The baggage issuing facility is e.g. a baggage conveyor belt at an airport. There, provision is made for a locating facility which locates baggage items with reference to a tag that is attached thereto, and passengers with reference to at least one of the identification features assigned to the passenger concerned. The locating facility controls the baggage issuing facility in order to deliver the located baggage item to the associated located passenger. The baggage issuing system offers greater convenience for passengers, since it avoids long waiting times and crowds of people at a baggage conveyor belt. Moreover, it is also possible to make the baggage issue more flexible. In particular, the baggage issuing system is suitable for baggage issue at destination airports and for baggage storage at railway stations.

### CROSS-REFERENCE TO RELATED APPLICATION

This application claims the priority, under 35 U.S.C. §119, of German application DE 10 2008 048 741.4, filed Sep. 24, 2008; the prior application is herewith incorporated by reference in its entirety.

### BACKGROUND OF THE INVENTION

### Field of the Invention

The invention relates to a system and a method for baggage issue, in particular via a baggage conveyor belt of an airport.

In the case of transportation or storage of baggage items which are separated from their owners, it is necessary to return the baggage item to the relevant owner at a subsequent point in time.

An airline passenger taking a baggage item usually deposits the baggage item at a check-in desk of a departure airport and, after the flight, collects the baggage item again at a baggage conveyor belt of an arrival airport. The baggage item deposited by the passenger in the departure airport is equipped with an ID strip, holding e.g. a barcode, for identification purposes, and is transported to the destination airport separately from the flight passenger. By virtue of a display unit in an arrival zone of the arrival airport, the passenger receives details of the baggage conveyor belt at which the baggage items of the relevant flight are issued. The passenger then waits for his or her baggage item at the baggage conveyor belt. After the airline passenger has visually identified the relevant baggage item, he or she takes it from the baggage conveyor belt and then leaves the arrival zone of the destination airport.

The conventional procedure for issuing baggage items, e.g. at airports, has a number of significant disadvantages. A user or passenger must first locate a display facility at the arrival or destination airport, indicating where the baggage items of the relevant flight are issued. It is a further disadvantage that the waiting time at a baggage conveyor belt, until the correct baggage item is issued, can vary significantly and can be very long in some cases, partly because many baggage items can be transported in an airplane and also because baggage items from several flights are issued on a shared baggage conveyor belt in many airports. As a result of the multiplicity of passengers, there is considerable crowding at a baggage conveyor belt, and this is aggravated by the fact that each passenger wants to keep sight of the baggage conveyor belt at all times in order to identify their baggage item or items.

It is a further disadvantage that many baggage items, e.g. black suitcases, can be very similar in appearance, and therefore it is difficult in some circumstances for a passenger to identify the relevant baggage item. Many passengers therefore equip their baggage items with additional identifying features such as e.g. straps or the like.

During the sometimes lengthy waiting times, the passengers, who are already stressed from a flight, are also obliged to maintain a continuous lookout for their baggage items at the baggage conveyor belt. It therefore often occurs that baggage items are not immediately recognized by a passenger, but are only recognized during the next or subsequent round of the circulating baggage conveyor belt.

A further disadvantage of conventional baggage issuing systems is that unauthorized third parties can easily remove baggage items from a baggage conveyor belt, without this being noticed by the authorized passenger. It is therefore relatively easy to steal baggage items from a baggage conveyor belt when they are issued.

A further disadvantage of conventional baggage issuing systems is that an incorrectly loaded or inadvertently uncollected baggage item can only be returned to the authorized passenger with considerable logistical effort.

### SUMMARY OF THE INVENTION

It is accordingly an object of the invention to provide a system and a method for baggage issue that overcomes the above-mentioned disadvantages of the methods and devices of this general type, which allow a baggage item to be selectively delivered to a passenger.

With the foregoing and other objects in view there is provided, in accordance with the invention, a baggage issuing system. The baggage issuing system contains a tag, at least one baggage issuing facility for issuing baggage items to passengers, and a locating facility for locating the baggage items with reference to the tag being attached to the baggage items, and for locating a passenger with reference to at least one identification feature being associated with the passenger concerned. The locating facility controls the baggage issuing facility to deliver a located baggage item to a located passenger.

The invention establishes a baggage issuing system containing at least one baggage issuing facility for issuing baggage items to passengers. Provision is made for a locating facility which locates baggage items with reference to a tag that is attached thereto in each case, and passengers with reference to at least one identification feature that has been assigned to the passenger concerned. The locating facility controls the baggage issuing facility in order to deliver the located baggage item to an associated located person.

In an embodiment of the baggage issuing system according to the invention, the locating facility derives the identification feature of a person from a device that is carried by the person.

This embodiment offers the advantage that no biometric data about passengers is required in order to identify them. The identification is coordinated by the device, which is carried, and therefore personal data relating to the passenger is not required or stored for the purpose of identification.

In an embodiment of the baggage issuing system according to the invention, the device which the person carries, and from which the identification feature of the person is derived, is a mobile terminal such as a mobile telephone, for example.

This embodiment has the advantage that most people already carry such a device with them.

In a further embodiment of the baggage issuing system according to the invention, the device carried by the person is an electronic boarding card.

This offers the advantage that every passenger at an airport already receives a boarding card, which can be adapted for the additional identification and location of the relevant passenger.

In an embodiment of the baggage issuing system according to the invention, the device carried by the person is an electronic boarding card which features an active or passive RFID tag.

This embodiment has the advantage that RFID tags function reliably and are of a size which allows them to be integrated in any desired device, even into boarding cards.

In an embodiment of the baggage issuing system according to the invention, the locating facility derives the identification feature of the person not from a device carried by the person but from a captured biometric body feature of the person.

This embodiment has the advantage that the identification and location of a person is particularly secure.

In an embodiment of the baggage issuing system according to the invention, the captured biometric body feature is a captured fingerprint of the person.

This embodiment has the advantage that sensors for capturing fingerprints are already widely utilized and technically proven.

In an embodiment of the baggage issuing system according to the invention, the locating facility exchanges messages via a wireless interface with the device carried by the person.

This has the advantage that a person can communicate interactively with the locating facility. For example, the person can send an inquiry to the locating facility, asking when and where the relevant baggage item can be collected.

In a further embodiment of the baggage issuing system according to the invention, the person is informed of a remaining waiting time before issue of a relevant baggage item, and a place of issue of the relevant baggage item, via a user interface of the carried device or via a display of the baggage issuing system.

This embodiment has the advantage that a person can utilize the remaining waiting time for other activities, e.g. shopping or other matters. Furthermore, with reference to the specified place of issue, a person can determine whether this location is far away and whether there is possibly still time for other activities.

In an embodiment of the baggage issuing system according to the invention, the baggage issuing facility receives the baggage items, which are equipped with tags, from a passenger transport vehicle for the transportation of people and baggage items.

In a further embodiment of the baggage issuing system according to the invention, the baggage issuing facility receives the baggage items, which are equipped with tags, from a baggage storage facility for the storage of baggage items.

The baggage issuing system according to the invention can be utilized in both airports and train stations or bus stations and the like.

In an embodiment of the baggage issuing system according to the invention, the baggage issuing facility is a baggage conveyor belt.

The baggage issuing system according to the invention is suitable for baggage items which are transported by a passenger airplane, passenger train, passenger ship or passenger bus.

Furthermore, the invention relates to a method for selectively issuing a baggage item. The method includes the steps of locating the baggage item that is to be issued, with reference to a tag which is attached to a baggage item; locating a person with reference to an identification feature that is assigned to the respective person, and—delivering the located baggage item to a located person who is associated with the baggage item.

In an embodiment of the method according to the invention for issuing the baggage item, provision is made for locating those people, within a predetermined zone, who were transported by the same passenger transport vehicle as the baggage item to be issued.

In an embodiment of the method according to the invention, the identification feature of the person is derived from a device which is carried by the person.

In an alternative embodiment of the method according to the invention, the identification feature of the person is derived from at least one captured biometric body feature of the person.

Furthermore, the invention provides a computer program which has program instructions for carrying out a method for selectively issuing a baggage item. The programmed instructions instruct a microprocessor to locate the baggage item that is to be issued, with reference to a tag which is attached to a baggage item; locate a person with reference to an identification feature that is assigned to the respective person, and deliver the located baggage item to a located person who is associated with the baggage item.

Furthermore, the invention provides a data storage medium which stores such a computer program.

Other features which are considered as characteristic for the invention are set forth in the appended claims.

Although the invention is illustrated and described herein as embodied in a system and a method for baggage issue, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block schematic diagram illustrating an exemplary embodiment of a baggage issuing system according to the invention;

FIG. 2 is an abstract illustration of the baggage issuing system according to the invention;

FIG. 3 is a flow diagram of an embodiment of the method according to the invention for selectively issuing baggage items;

FIGS. 4A, 4B, 4C are illustrations showing exemplary embodiments for the attachment of tags which can be used for locating baggage items in the baggage issuing system according to the invention; and

FIGS. 5A, 5B are perspective views showing embodiment variants having a divisible tag.

### DETAILED DESCRIPTION OF THE INVENTION

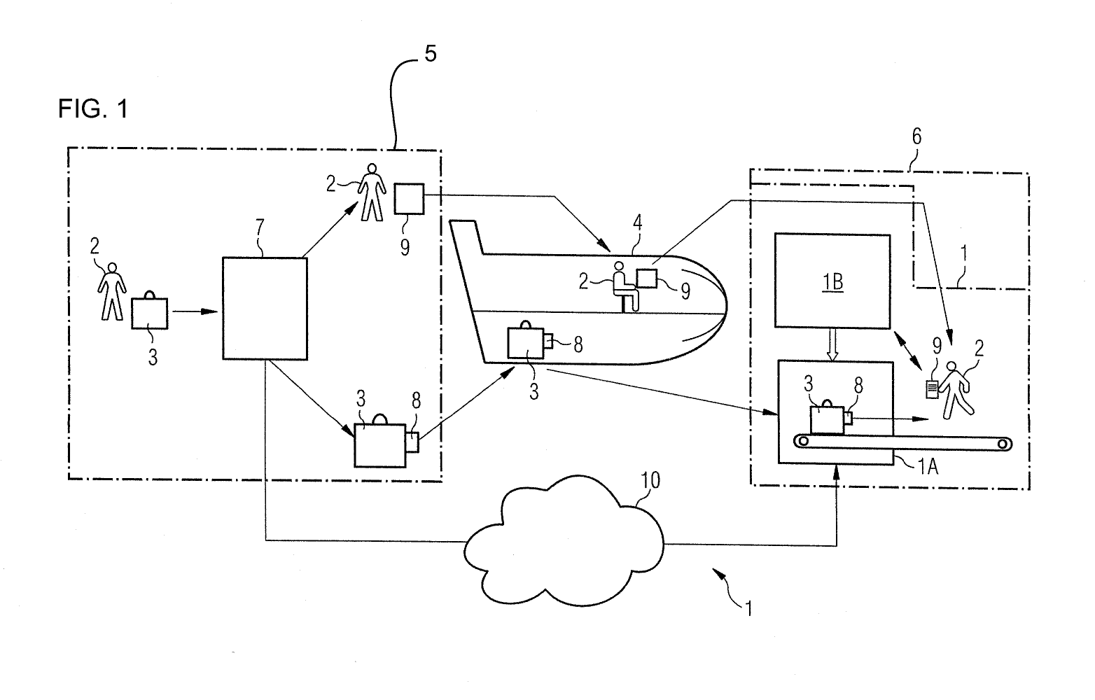

Referring now to the figures of the drawing in detail and first, particularly, to FIG. 1 thereof, there is shown an exemplary application of a baggage issuing system 1 according to the invention. The baggage issuing system 1 illustrated in FIG. 1 is a baggage issuing system of an airport. A passenger 2, accompanied by baggage item 3, is flying on an airplane 4 from a departure airport 5 to an arrival or destination airport 6, in which the baggage issuing system 1 according to the invention is located. The passenger 2, with the relevant baggage item 3, proceeds to a check-in desk of a check-in baggage entry system 7 within the departure airport 5. The baggage item 3 is separated from the passenger 2, who also receives a boarding card, at the check-in desk 7. A tag 8, which allows identification of the baggage item 3 and the associated passenger 2, is attached to the baggage item 3.

The assignment of the baggage item 3 to the passenger 2 can take place in various ways. In one possible embodiment variant, the assignment takes place by a biometric body feature of the person 2. For example, a fingerprint of the person 2 is captured at the check-in 7 and is stored in conjunction with personal data of the passenger 2 in the tag 8 of the associated baggage item 3. In this embodiment, sensors for capturing biometric body features of the passenger 2 are provided in the check-in zone, e.g. a fingerprint scanner, an iris scanner or other facilities for capturing biometric body features.

In an alternative embodiment, the identification feature for identification of the passenger 2 is derived with reference to a device 9 that is carried by the passenger 2. This device 9 can be e.g. an electronic boarding card which contains an active or passive RFID tag. In an alternative embodiment, the carried device 9 can be a mobile terminal, e.g. a mobile telephone of the passenger 2. In this embodiment variant, a device number and/or a SIM card number is linked to an assigned ID number of the baggage item 3, and the linked data is then stored in unencrypted or/and encrypted format in a memory area of the carried device 9.

The person or passenger 2 carrying the device 9, e.g. the electronic boarding card, is then transported with the baggage item 3 (equipped with the tag 8), preferably by the same transport vehicle 4, e.g. an airplane. In the exemplary embodiment illustrated in FIG. 1, the airplane 4 flies from the departure airport 5 to the destination airport 6, where the passenger 2 leaves the airplane 4. The baggage issuing system 1 according to the invention is provided at the destination airport 6. This contains a baggage issuing facility 1A for the issue of baggage items 3 to passengers 2. The baggage issuing facility 1A is, for example, a baggage conveyor belt from which the people or passengers 2 can take the relevant baggage item 3. The baggage issuing system 1 also contains a locating facility 1B which locates baggage items 3 with reference to the tag 8 that is attached thereto in each case, and the people or passengers 2 with reference to at least one of the identification features assigned to a respective person 2. The identification feature can be a biometric body feature which was captured at the departure airport 5 or an identification feature that was derived from the carried device 9. The locating facility 1B of the baggage issuing system 1 controls the baggage issuing facility 1A for the selective delivery of the located baggage item 3 to an associated located person 2.

In a possible embodiment of the baggage issuing system according to the invention 1, the passenger 2 at the destination airport 6 proceeds to any baggage conveyor belt 1A and automatically receives the relevant baggage item or items 3 via this baggage conveyor belt 1A. This has the advantage that the person 2 at the destination airport 6 does not have to seek out a specific baggage conveyor belt. This embodiment also offers the advantage that various baggage conveyor belts can be equally loaded at the destination airport 6.

In an embodiment, the locating facility 1B can exchange messages via a wireless interface with the device 9 that is carried by the person 2, i.e. with the electronic boarding card or with a mobile telephone, for example. As a result of this, the user or the passenger 2 has the possibility of communicating with the baggage issuing system 1. For example, a user 2 can send an inquiry to the locating facility 1B, in order to determine where the planned baggage issue is to occur or at which baggage conveyor belt the baggage issue is to occur. A passenger 2 also has the possibility of informing the locating facility 1B that he or she would prefer the baggage issue to take place at a specific later time, if the passenger wants to deal with another activity beforehand, e.g. participate in a meeting or make purchases. After completion of the activity, e.g. two hours later, the passenger 2 can go to the baggage conveyor belt 1A and promptly receive the relevant baggage item 3. In the meanwhile, the passenger 2 is not encumbered with carrying the baggage item 3 around. In particular, this also offers the airport operator of the destination airport 6 the advantage that a passenger 2 can make use of the services available there in a relaxed manner, without being encumbered by the baggage item 3, e.g. by doing some shopping.

In a further embodiment, by use of a display unit of the baggage issuing system 1, the user or the passenger 2 is notified of a remaining waiting time before the issue of a relevant baggage item 3, and a place of issue of the baggage item 3. In this embodiment variant, the passenger 2 is at least not obliged to wait the whole time at a baggage conveyor belt 1A for the relevant baggage item 3. Moreover, the baggage issuing system 1 can notify the passenger 2 that, for example, it will not be possible to issue the relevant baggage item 3 for half an hour due to high traffic density on the baggage conveyor belt 1A. This gives the passenger 2 the opportunity to carry out other activities without worrying in the meanwhile. In a possible embodiment, using a data transfer protocol, the locating facility 1B exchanges messages with the passenger 2 via a user interface of the carried device 9. The communication and locating facility 1B can send a message to a specific passenger 2 via the device 9, which has a specific address. The passenger 2 can initiate a message and send it to the baggage issuing system 1, e.g. by pressing a key on a keypad of the user interface of the carried device 9. The baggage issuing system 1 can check the position of the carried device 9 having a specific address or determine the position of a passenger 2. Furthermore, the locating facility 1B can detect if a mobile terminal 9 or a passenger 2 enters or leaves a specific geographical zone of the destination airport 6. At the destination airport 6, the device which is given to the flight passenger 2 or the device 9 which is carried by the flight passenger 2 informs the flight passenger 2 when the relevant baggage item 3 will arrive at an issuing conveyor belt 1A. In this case, e.g. by a display of a mobile telephone or by a corresponding alarm signal, the flight passenger 2 can be notified, e.g. to the minute, when the relevant baggage item 3 appears on the baggage conveyor belt 1A. As a result of this, crowding of many passengers 2 at a baggage conveyor belt 1A can be avoided. Alternatively, the baggage item 3 is only issued at the baggage conveyor belt 1A when the corresponding passenger 2 is standing at the relevant baggage conveyor belt 1A. Protection against theft is increased in this way.

In an embodiment variant, the baggage items 3 are distributed over various baggage conveyor belts 1A, e.g. on the basis of name, seat, ticket ID or similar. For example, the baggage items 3 of the business class are output on a different baggage conveyor belt 1A than the baggage items 3 of the economy class, wherein the passengers 2 are informed of the baggage conveyor belts 1A that have been assigned to them, e.g. via the carried device 9.

Further variants of the baggage issuing system according to the invention 1 are possible. For example, the baggage issue can take place selectively for the first time at the baggage issuing facility 1A which is situated inside a car park or inside a nearby airport hotel. The selective baggage issue can take place on the basis of the locating information that is available about the baggage item 3 and the associated passenger 2, and on the basis of further information about e.g. the car parking slot of the passenger 2, the parking slot information having been stored at the time of departure, wherein the baggage items 3 of the passenger 2 are transported in such a way that the passenger 2 can collect the relevant baggage items 3 at a preferred baggage issuing point or a corresponding baggage issuing facility 1A at any time. In a possible embodiment, the locating facility 1B therefore regularly transfers location updates to a baggage issuing point (PUSH location) of the baggage issuing system 1. At the baggage issue belt 1A, the baggage item 3 is either explicitly requested by a corresponding request from the passenger 2, e.g. by pressing a key on the terminal 9, or implicitly requested by virtue of the passenger 2 being present in a predetermined issue zone. This embodiment variant has the advantage that dedicated baggage issue zones are no longer required and the convenience for the passengers 2 can be greatly increased. For example, it is possible to provide a special service for first-class passengers, in which the baggage item 3 is issued at a parked car or in the hotel of the passenger 2.

In a possible embodiment, the transfer of the linking data from the departure airport 5 to the destination airport 6 is done via a network 10 as illustrated in FIG. 1. In an alternative embodiment, the transportation of the linking information takes place in a storage unit or data storage medium in the transport vehicle 4.

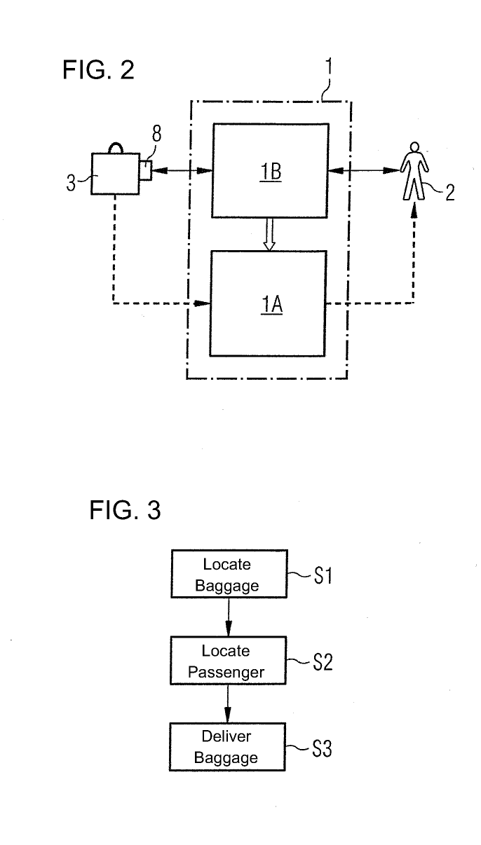

FIG. 2 schematically shows the baggage issuing system 1 according to the invention. The baggage issuing system 1 according to the invention is not limited to airports. It is also suitable for baggage items 2 which are transported using other transport vehicles, e.g. passenger trains, passenger ships or passenger buses. Furthermore, the baggage issuing system 1 according to the invention is not limited to transported baggage items 3, but can also be utilized for baggage storage, e.g. in a train station.

FIG. 3 shows a simple flow diagram of a possible embodiment of the method according to the invention for selective issue of a baggage item 3.

In a step S1, the baggage item 3 to be issued is located with reference to a tag 8 which is attached to the baggage item 3.

In a step S2, people or passengers 2 are located with reference to at least one identification feature which is assigned to the person concerned. In this case, in an embodiment variant, the identification feature is derived from a device 9 which is carried by the person 2, e.g. from a boarding card or a mobile telephone. In a further embodiment variant, the identification feature of the person 2 is derived from a captured biometric body feature of the person 2, e.g. a fingerprint of one or more fingers of the person 2.

In a further step S3, the located baggage item 3 is delivered to the located person 2 who is associated with the baggage item 3. In a possible embodiment of the method according to the invention, for the purpose of issuing the baggage item 3, those people 2 are located, within a predetermined zone, who were transported with the same passenger transport vehicle 4 as the baggage item 3 to be issued. This allows the location to take place more quickly if there is a multiplicity of people or passengers 2.

Various possibilities exist for attaching the tag 8 to the baggage item 3 for subsequent identification.

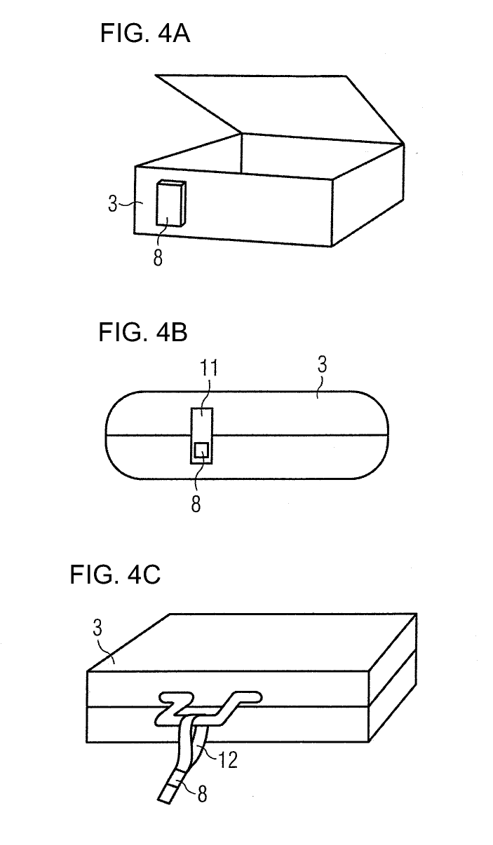

FIGS. 4A, 4B, 4C show various embodiment variants for attaching the tag 8 to the baggage item 3. The baggage item 3 illustrated in FIGS. 4A to 4C is a suitcase.

In the embodiment variant illustrated in FIG. 4A, the tag 8 is attached to the baggage item 3 itself, e.g. integrated in the baggage item 3. Alternatively, the tag 8 can also be placed in the suitcase 3.

In the embodiment variant illustrated in FIG. 4B, the tag 8 is attached to a sealing strip 11 which seals an upper and lower suitcase shell.

In the embodiment variant illustrated in FIG. 4C, the tag 8 is integrated in a strip 12 which is attached to the baggage item 3 in a conventional manner at a check-in desk.

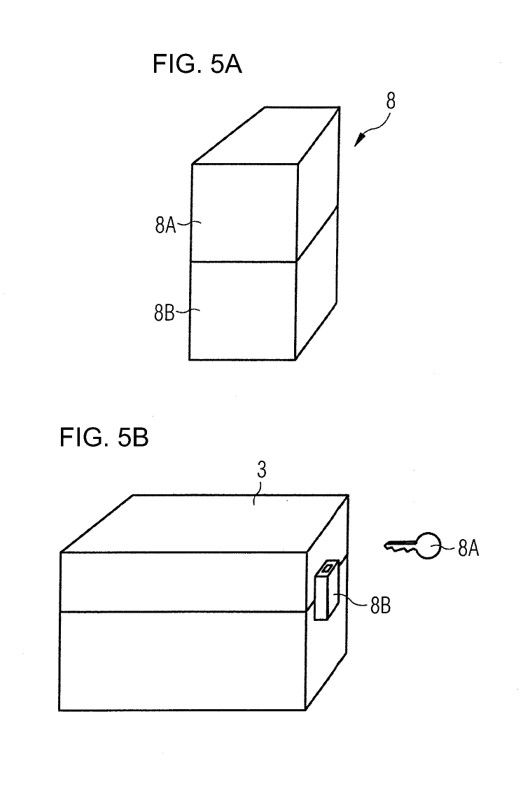

In a further embodiment variant, the user 2 receives one part of a divisible tag, as illustrated in FIG. 5. In this case, e.g. the upper part 8A of the divisible tag 8 illustrated in FIG. 5A is a device 9 which is carried by the person 2, and the lower part 8B of the divisible tag 8 is attached to the baggage item 3. In a possible embodiment, both parts 8A, 8B of the divisible tag 8 can be connected together by use of a push-in connector. The divisible tag 8 is separated at the check-in desk of the departure airport 5, wherein the passenger 2 receives e.g. the upper part 8A of the divisible tag 8 and e.g. the lower part 8B of the divisible tag 8 is attached to the baggage item 3.

In a possible embodiment variant, the divisible tag illustrated in FIG. 5B is integrated in the baggage item 3, wherein the passenger 2 takes the upper part 8A of the divisible tag 8 at the check-in desk and keeps it with him or her during the flight. The upper part 8A of the divisible tag 8 can be located by the locating facility 1B at the destination airport 6. The baggage item 3, which is equipped with the lower divisible tag part 8B, is then selectively delivered to the passenger 2.

The upper part 8A of the divisible tag 8 can be integrated in a key, for example, which can be inserted into a lock as a lower part 8B of a divisible tag 8.

In a possible embodiment variant, at the destination airport 6, the passenger 2 can insert the key 8A into the lock 8B of the divisible tag 8 in order to receive the baggage item 3, wherein a signal is generated automatically and signals that the baggage item 3 has been correctly received. In this way, the locating facility 1B can be notified that an authorized passenger 2 has received the relevant baggage item 3. This offers an additional protection against unauthorized removal of baggage items 3. It is also possible to record whether a passenger 2 has received a baggage item 3 or not.

1. A baggage issuing system, comprising:
a tag;
at least one baggage issuing facility for issuing baggage items to passengers; and
a locating facility for locating the baggage items with reference to said tag being attached to the baggage items, and for locating a passenger with reference to at least one identification feature being associated with the passenger concerned, said locating facility controlling said baggage issuing facility to deliver a located baggage item to a located passenger.

2. The baggage issuing system according to claim 1, further comprising a device, said locating facility deriving the identification feature of the passenger from said device carried by the passenger.

3. The baggage issuing system according to claim 2, wherein said device which is carried by the passenger is selected from the group consisting of a mobile terminal and a tag.

4. The baggage issuing system according to claim 3, wherein said mobile terminal is a mobile telephone.

5. The baggage issuing system according to claim 2, wherein said device which is carried by the passenger is an electronic boarding card.

6. The baggage issuing system according to claim 2, wherein said device which is carried by the passenger features one of an active RFID tag and a passive RFID tag.

7. The baggage issuing system according to claim 1, wherein said locating facility derives the identification feature of the passenger from a captured biometric body feature of the passenger.

8. The baggage issuing system according to claim 7, wherein the captured biometric body feature is a captured fingerprint of the passenger.

9. The baggage issuing system according to claim 2, wherein said locating facility exchanges messages via a wireless interface with said device which is carried by the passenger.

10. The baggage issuing system according to claim 9,
wherein said device has a user interface;
further comprising a display unit; and
the passenger is notified, via one of said user interface of the device and said display unit, of a remaining waiting time before issue of an associated baggage item and of a place of issue of the associated baggage item.

11. The baggage issuing system according to claim 1, wherein said baggage issuing facility receives the baggage items, which are equipped with said tag, from one of a passenger transport vehicle for transporting the passengers and the baggage items and from a baggage storage facility for a storage of the baggage items.

12. The baggage issuing system according to claim 1, wherein said baggage issuing facility has a baggage conveyor belt.

13. The baggage issuing system according to claim 11, wherein the passenger transport vehicle is selected from the group consisting of a passenger airplane, a passenger train, a passenger ship and a passenger bus.

14. A method for selectively issuing a baggage item, which comprises the steps of:
locating the baggage item that is to be issued, with reference to a tag which is attached to the baggage item;
locating a passenger with reference to at least one identification feature that is assigned to the passenger; and
delivering the baggage item located to the passenger who is associated with the baggage item.

15. The method according to claim 14, wherein for issuing the baggage item, provision is made for locating passengers, within a predetermined zone, who were transported in a same passenger transport vehicle as the baggage item to be issued.

16. The method according to claim 14, which further comprises deriving the identification feature of the passenger from a device which is carried by the passenger.

17. The method according to claim 14, which further comprises deriving the identification feature of the passenger from at least one captured biometric body feature of the passenger.

18. A computer readable medium having computer-executable instructions for selectively issuing a baggage item, wherein the instructions instruct a microprocessor to perform the following steps:
locate the baggage item that is to be issued, with reference to a tag which is attached to the baggage item;
locate a passenger with reference to at least one identification feature that is assigned to the passenger; and
deliver the baggage item located to the passenger who is associated with the baggage item.

19. A data storage medium with an executable program stored thereon for selectively issuing a baggage item, wherein the program instructs a microprocessor to perform the following steps:
locate the baggage item that is to be issued, with reference to a tag which is attached to the baggage item;
locate a passenger with reference to at least one identification feature that is assigned to the passenger; and
deliver the baggage item located to the passenger who is associated with the baggage item.
